(19) United States
(12) Patent Application Publication
(10) Pub. No.: US 2004/0179437 A1
(43) Pub. Date: Sep. 16, 2004

(54) Optical pickup device, method of assembling the same, and optical disk device

(75) Inventor: Tooru Washiyama, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/781,933

(22) Filed: Feb. 20, 2004

(30) Foreign Application Priority Data
Feb. 21, 2003 (JP) 2003-044522

(51) Int. Cl. G11B 7/00

(52) U.S. Cl. 369/44.11

(57) ABSTRACT

0 In an optical pickup of the invention, the center of a laser beam incident on a dichroic prism can easily correspond to the center of an objective lens by a heat sink, which is held by a boss portion inserted into a through hole provided in an optical base and a boss plate having a plane portion in which the boss portion can be moved in the through hole in a direction orthogonal to an axis line of the boss portion.

### CROSS-REFERENCE TO RELATED APPLICATIONS

This application is based upon and claims the benefit of priority from the prior Japanese Patent Application No. 2003-044522, filed Feb. 21, 2003, the entire contents of which are incorporated herein by reference.

### BACKGROUND OF THE INVENTION

1. Field of the Invention

The present invention relates to an optical pickup and an optical disk device for recording information on an optical disk used as an information recording medium or reproducing the information from the optical disk.

2. Description of the Related Art

In optical disks for use as an information recording medium, a read-only optical disk typified by a CD (compact disc for music) and DVD-ROM, a write-once optical disk typified by a CD-R and DVD-R, a rewritable optical disk typified by an external memory of a computer and a recording/reproducing video disk, and the like have been already practically used.

In recent years, in order to correspond to the rapid increase in recording capacity required in information-related instruments and broadcast-related instruments, an increase in the recording capacity is demanded in optical disks. Therefore, while research is going on to decrease the condensing spot diameter by shortening the laser beam wavelength (decrease in a condensing spot diameter) or to utilize of a super-resolution technology in order that the recording density is increased, a mastering technology such as electron beam exposure is studied in order to shorten a track pitch and a mark pit pitch.

For example, with reference to the decrease in the wavelength of the laser beam, a standard which employs a blue-violet laser beam having a wavelength of 405 nm is already defined.

Thus, higher accuracy is required for accuracy in position and assembly accuracy of the optical pickup for recording the information in the optical disk.

In Jpn. Pat. Appln. KOKAI Publication No. 2002-150599, it is described that a grating element incorporated in the optical pickup can be rotated in order to increase the assembly accuracy and accuracy in position the in assembling the optical pickup.

In the invention disclosed in Jpn. Pat. Appln. KOKAI Publication No. 2002-150599, a module 70 including the grating element can be rotated in an arbitrary direction by a projection 49 and a ring-shaped guide portion 50 in the optical pickup.

However, currently, due to the demand of the further miniaturization for the optical pickup, the semiconductor laser element which outputs the light beam and a photodetector which receives a reflected light beam reflected from the optical disk under a predetermined condition and obtains an electrical signal for focus control and tracking control of an objective lens and for signal reproduction, have been already integrated with each other. Accordingly, the particularly high accuracy is required for optical axis alignment of the light beam which passes through optical elements and the objective lens guiding the light beam from the laser element to the objective lens.

In the laser element, on the other hand, a heat sink which radiates heat from the laser element is integrated with the laser element. In the case where the blue-violet laser beam having a wavelength of 405 nm is used, consideration of an energy distribution of the light beam is also required in order to improve utilization efficiency of the light beam. As a result, there is a problem that alignment time is increased in aligning an optical axis of the light beam which passes through the optical elements and the objective lens guiding the light beam from the laser element to the objective lens.

Generally the heat sink is provided in the laser element. However, a heat sink shape from form which heat is radiated securely, and a laser element holding mechanism or the heat sink shape which has compatibility between fixing method and an alignment space for aligning the optical axis are not established yet.

Therefore, there is the problem that the energy of the light beam condensed on the recording surface of the optical disk through the objective lens is not uniform.

### BRIEF SUMMARY OF THE INVENTION

According to the present invention, there is provided an optical pickup device comprising: a light source which emits a light beam; an optical base which holds the light source; a dichroic prism which is fixed to the optical base, the dichroic prism reflecting the light beam emitted from the light source; a mirror which is fixed to the optical base, the mirror receiving the light beam reflected from the dichroic prism; a heat sink which is integrated with the light source, the heat sink releasing heat from the light source; and a heat sink holding member which can position the heat sink at a predetermined position in the optical base.

According to the present invention, there is further provided an optical disk device comprising: a light source which emits a light beam; an optical base which holds the light source; a dichroic prism which is fixed to the optical base, the dichroic prism reflecting the light beam emitted from the light source; a mirror which is fixed to the optical base, the mirror receiving the light beam reflected from the dichroic prism; a heat sink which is integrated with the light source, the heat sink releasing heat from the light source; a heat sink holding member which can position the heat sink at a predetermined position in the optical base; and a photodetector which detects the reflected light beam in which the light beam is reflected at a recording medium and outputs an electric signal having a magnitude corresponding to intensity of the reflected light beam.

According to the present invention, there is still further provided a method of assembling a dual wavelength optical pickup device including an objective lens which condenses a light beam onto a recording medium or captures the light beam from a recording medium, a prism mirror which folds an optical path of the light beam passing through the objective lens at a predetermined angle, a first light source which emits a light beam having a first wavelength, a second light source which outputs a light beam having a second wavelength, a collimating lens which collimates the light beam from the first light source, a dichroic prism which transmits the light beam having the first wavelength collimated by the collimating lens toward the prism mirror and reflects the light beam from the second light source toward the prism mirror, and an optical base which holds each of elements, the method comprising the steps of: fixing the prism mirror at a predetermined position in the optical base directly or through a holding member; fixing the collimating lens at the predetermined position in the optical base directly or through the holding member so that the light beam from the first light source can be incident on the prism mirror under a predetermined condition;

fixing the dichroic prism at the predetermined position in the optical base directly or through the holding member, while a virtual light source for assembly is used instead of the second light source and the light beam from the virtual light source is monitored as the light beam reflected from the prism mirror; positioning the second light source, which is fixed to a heat sink on the basis of a monitor signal obtained by an alignment photodetector or a detector of an autocollimator, at the predetermined position in the optical base; and bonding a heat sink holding member to the optical base, the heat sink holding member holding the heat sink so that a relative position between the heat sink and the optical base can be changed.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the preferred embodiment given below, serve to explain the principles of the invention.

FIG. 1 is a schematic view illustrating an example of an optical disk device to which an embodiment of the invention is applied;

FIG. 2 is a schematic view illustrating an example of an optical pickup which is incorporated in the optical disk device shown in FIG. 1;

FIG. 3 is a block diagram illustrating an example of a signal processing system in the optical disk device shown in FIGS. 1 and 2;

FIGS. 4A and 4B are a schematic view illustrating an example of a heat sink which is incorporated in the optical pickup shown in FIG. 2;

FIGS. 5A and 5B are a schematic view illustrating an example of a light-emitting/receiving unit for DVD which is incorporated in the optical pickup shown in FIG. 2;

FIG. 6 is a schematic view illustrating an example of a configuration in which the light-emitting/receiving unit for DVD shown in FIGS. 5A and 5B is mounted on the optical disk device shown in FIG. 2;

FIG. 7 is a schematic view illustrating an example of a defect caused by the configuration, in which the light-emitting/receiving unit for DVD is mounted on the optical disk device, shown in FIG. 6;

FIG. 8 is a schematic-view illustrating an example of a main part in a mounting structure substituting for the configuration, in which the light-emitting/receiving unit for DVD is mounted on the optical disk device, shown in FIG. 6;

FIG. 9 is a schematic view illustrating an example of a light-emitting/receiving unit holding structure which is combined with the mounting structure shown in FIG. 6;

FIG. 10 is a schematic view illustrating an example of a state in which the mounting structure shown in FIG. 9 is attached to the mounting structure shown in FIG. 8;

FIG. 11 is a schematic view illustrating a state in which the mounting structure shown in FIG. 9 can be moved while the mounting structure shown in FIG. 9 is attached to the mounting structure shown in FIG. 8;

FIGS. 12A and 12B are a schematic view illustrating a feature in molding the mounting structure shown in FIG. 9;

FIG. 13 is a schematic view illustrating an example of a process for assembling the optical pickup which uses the light-emitting/receiving unit holding structure and a mounting mechanism shown in FIGS. 8 to 10; and

FIG. 14 is a schematic view illustrating an example of a process for assembling the optical pickup which uses the light-emitting/receiving unit holding structure and a mounting mechanism shown in FIGS. 8 to 10.

### DETAILED DESCRIPTION OF THE INVENTION

Referring to the accompanying drawings, preferred embodiments of the invention will be described in detail below.

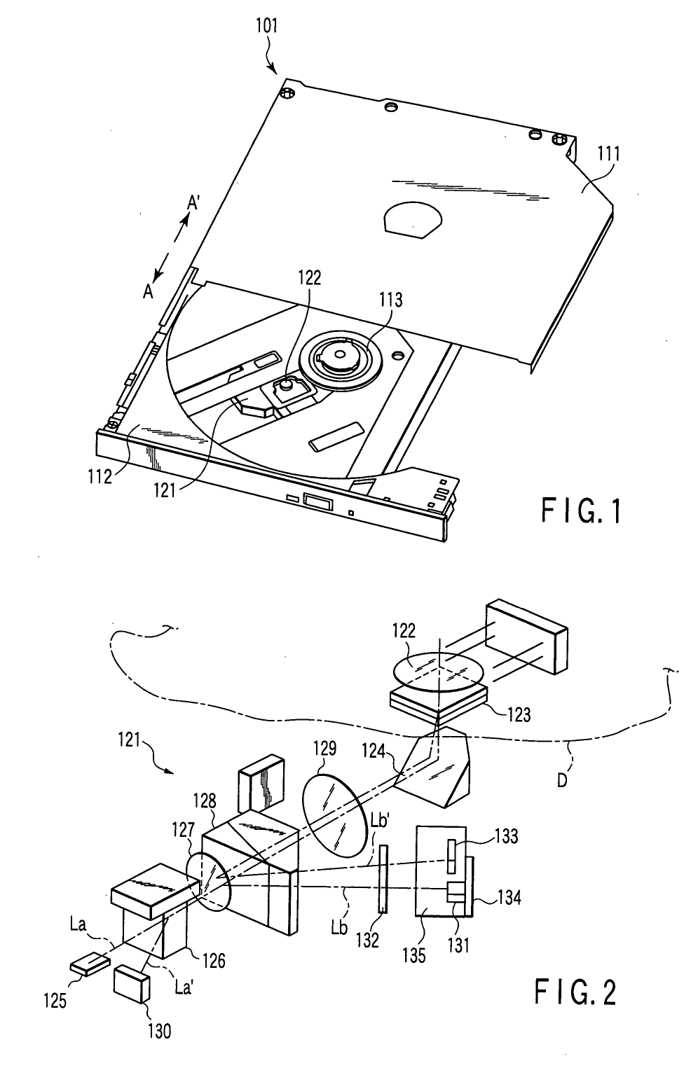

FIG. 1 is a schematic view illustrating an example of an optical disk device including an optical pickup of an embodiment of the invention.

An optical disk device 101 shown in FIG. 1 includes a housing 111 and a table unit 112 which is formed to be able to perform eject operation (movement in the direction of an arrow A) and loading operation (movement in the direction of an arrow A′) relative to a housing 111.

A turntable 113 which rotates an optical disk D at a predetermined number of revolutions is provided in the substantial center of the table unit 112. Since FIG. 1 shows the case in which the table unit 113 is ejected while the optical disk D is not inserted, a part of an optical pickup 121 and an objective lens 122 incorporated in the optical pickup 121 can be seen with the optical pickup 121 and the objective lens 122 exposed.

FIG. 2 is a schematic view illustrating an operating principle of the optical pickup 121 while extracting elements of the optical pickup 121 in the optical disk device 101 shown in FIG. 1.

As shown in FIG. 2, the optical pickup 121 includes the objective lens 122 which condenses the light beam, i.e. a laser beam onto a recording surface of the optical disk D and takes in the laser beam reflected from the optical disk D (hereinafter referred to as reflected laser beam).

A first holographic element 123 is provided at a predetermined position on the side of the objective lens 122 which is opposite to the optical disk D. The first holographic element 123 gives predetermined optical characteristics of the laser beam directed toward the optical disk D through the objective lens 122 and the reflected laser beam from the optical disk D.

The objective lens 122 and the first holographic element 123 can be arbitrarily moved in a direction orthogonal to the recording surface of the optical disk D and in the direction orthogonal to a guide groove or a recording mark string provided in the recording surface with a three-axis actuator (not described in detail).

A prism mirror 124 is provided at a predetermined position in front of the first holographic element 123, i.e., on the side opposite from the objective lens 122. The prism mirror 124 reflects the laser beam guided in the direction substantially parallel to the recording surface of the optical disk D toward the objective lens 122.

A first laser element 125 is provided at the position where the laser beam can be incident on the prism mirror 124. The first laser element 125 emits the laser beam having, e.g., the near infrared wavelength toward the direction substantially parallel to the recording surface of the optical disk D. For example, the first laser element 125 is employed to reproduce the information from the CD optical disk.

A light-receiving characteristics setting element 126 in which a diffraction grating and a non-polarizing hologram are integrally formed, a coupling lens 127, a dichroic prism 128, and a collimating lens 129 are provided between the first laser element 125 and the prism mirror 124 in the order from the side of the laser element 125. A first photodetector 130 detecting the reflected laser beam from the optical disk D is located at the position satisfying a predetermined condition for the position where the first laser element 125 is provided. The reflected laser beam to which the light-receiving characteristics setting element 126 gives predetermined diffraction is incident on the first photodetector 130.

A second laser element 131, which emits the laser beam having, e.g., a red wavelength, is provided at the position where the laser beam can be incident on the prism mirror 124 by the reflection from the dichroic prism 128. For example, the second laser element 131 is employed to reproduce the information from the DVD standard optical disk and to write the information in the CD optical disk and the DVD standard optical disk.

An FM holographic element 132 is located at the predetermined position between the second laser element 131 and the dichroic prism 128. The FM holographic element 132 gives the characteristics suitable for information recording in the optical disk D to the laser beam radiated from the second laser element 131. The FM holographic element 132 also has a function of giving predetermined light-receiving characteristics to the reflected laser beam from the optical disk D.

A second photodetector 133 detecting the reflected laser beam from the optical disk D is provided at the position satisfying the predetermined condition for the position where the second laser element 131 is provided. The reflected laser beam to which the FM holographic element 132 gives the predetermined diffraction is incident to the second photodetector 133. The second laser element 131, the FM holographic element 132, and the second photodetector 133 are integrated in the form of a light-emitting/receiving unit for DVD 135 while a heat sink 134 is included in the light-emitting/receiving unit for DVD 135.

In the case where the information is reproduced from the CD optical disk using the optical pickup 121 shown in FIG. 2, the light-receiving characteristics setting element 126 gives predetermined wavefront characteristics to the a laser beam La having a wavelength of, e.g. 780 nm output from the first laser element 125, predetermined coupling efficiency is secured by the coupling lens 127, and the laser beam La is incident to the dichroic prism 128.

The laser beam La incident to the dichroic prism 128 is transmitted through the dichroic prism 128 and collimated with the collimating lens 129, and the traveling direction of the laser beam La is folded toward the objective lens 122 with the prism mirror 124.

The laser beam La directed toward the objective lens 122 with the prism mirror 124 passes through the first holographic element 123, and the laser beam La is condensed on the recording surface of the optical disk D.

The reflected laser beam La′ which has been reflected on the recording surface of the optical disk D passes through the first holographic element 123 and returns to the prism mirror 124, and the traveling direction of the laser beam La′ is folded in substantially parallel to the recording surface of the optical disk D again.

The reflected laser beam La′ folded with the prism mirror 124 is incident on the collimate lens 129 and guided to the dichroic prism 128.

Then, the reflected laser beam La′ returned to the dichroic prism 128 is transmitted through the dichroic prism 128 and directed toward the first photodetector 130 with the light-receiving characteristics setting element 126.

Accordingly, the reflected laser beam La′ whose intensity is changed and returned according to the information recorded on the optical disk D is incident on the first photodetector 130.

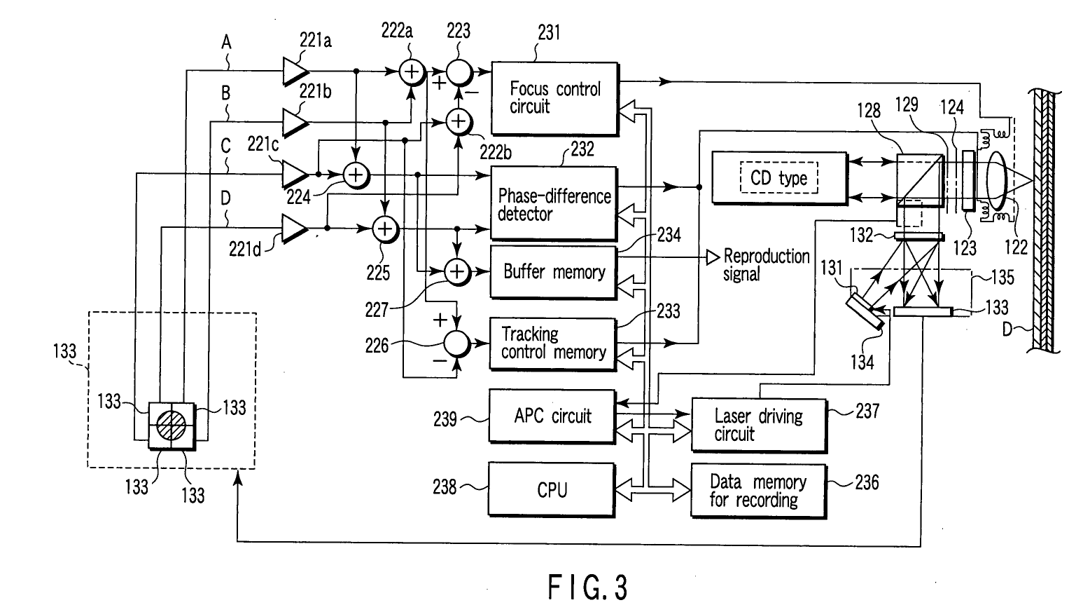

The reflected laser beam La′ is photoelectrically converted with the first photodetector 130, and the photoelectrically converted output is processed with a signal processing unit (described later using FIG. 3) and outputted to an external device or a temporary storage device in the form of the signal corresponding to the information recorded in the optical disk D.

In the case where the information is recorded in the DVD standard optical disk, the FM holographic element 132 gives the predetermined wavefront characteristics to a laser beam Lb having a wavelength of, e.g., 660 nm outputted from the second laser element 131, and the laser beam Lb is incident on the dichroic prism 128.

The laser beam Lb incident on the dichroic prism 128 is reflected from the dichroic prism 128 and guided to the collimating lens 129.

The laser beam Lb guided to the collimating lens 129 is collimated with the collimating lens 120, and the traveling direction of the laser beam Lb is folded toward the objective lens 122 with the prism mirror 124.

The laser beam Lb directed toward the objective lens 122 with the prism-mirror 124 passes through the first holographic element 123, and the laser beam Lb is focused on the recording surface of the optical disk D.

The light intensity of the laser beam Lb condensed on the recording surface of the optical disk D has been modulated according to the information to be recorded with the signal processing unit, which will be shown in FIG. 3, so that a recording mark, i.e. a pit is formed in the recording film when energy per time is sufficient to generate phase transition of the recording film in the optical disk D.

The reflected laser beam Lb′ which has been reflected on the recording surface of the optical disk D passes through the first holographic element 123 and returns to the prism mirror 124, and the traveling direction of the laser beam Lb′ is folded in substantially parallel to the recording surface of the optical disk D again. The laser beam Lb′ returns to the dichroic prism 128 through the collimating lens 129.

Then, the reflected laser beam Lb′ returned to the dichroic prism 128 is reflected from the dichroic prism 128 and directed toward the second photodetector 133 with the FM holographic element 132.

A part of the reflected laser beam Lb′ incident to the second photodetector 133 is employed to generate a focus error signal and a tracking error signal in the signal processing system shown in FIG. 3. Namely, while the objective lens 122 is focus-locked at the position where the objective lens 122 is on-focused on the recording surface of the optical disk D which is not described in detail, tracking is controlled so that the center of the laser beam corresponds to the center of the track or the pit string of the information pits which is previously formed in the recording surface of the optical disk D.

In the case where the information is reproduced from the DVD standard optical disk, in the same way as the information recording, the laser beam Lb condensed on the recording surface of the optical disk D is reflected from the optical disk D while the intensity of the reflected laser beam Lb is changed according to the recording mark (pit string) recorded on the recording surface.

The reflected laser beam Lb′ reflected from the optical disk D passes through the first holographic element 123 and returns to the prism mirror 124, and the traveling direction of the laser beam Lb′ is folded in substantially parallel to the recording surface of the optical disk D again. The laser beam Lb′ returns to the dichroic prism 128 through the collimating lens 129.

Then, the reflected laser beam Lb′ returned to the dichroic prism 128 is reflected from the dichroic prism 128 and directed toward the second photodetector 133 with the FM holographic element 132.

In the signal processing system shown in FIG. 3, a part of the reflected laser beam Lb′ incident to the second photodetector 133 is output to the external device or the temporary storage device in the form of the signal corresponding to the reproducing signal obtained by adding the output of the second photodetector 133.

FIG. 3 is a block diagram illustrating an example of the signal processing system in the optical disk device shown in FIGS. 1 and 2. In FIG. 3, the reproduction of the signal from the CD optical disk (laser beam passing through the dichroic prism) will be omitted, and the output signal of the second photodetector, i.e. the reproducing signal from the DVD standard optical disk, focus control, and tracking control will be mainly described.

The second photodetector 133 includes a first area photodiode 133A, a second area photodiode 133B, a third area photodiode 133C, and a fourth area photodiode 133D. Outputs A, B, C, and D of the photodiodes 133A to 133D are amplified to a predetermined level by a first amplifier 221a, a second amplifier 221b, a third amplifier 221c, and a fourth amplifier 221d respectively.

In the outputs A to D of the amplifiers 221a to 221d, the outputs A and B are added by a first adder 222a and the outputs C and D are added by a second adder 222b.

The outputs of the adders 222a and 222b are added by an adder 223, while a sign of the outputs C and D is reversed to the outputs A and B.

The result of the addition of the adder 223 is supplied to a focus control circuit 231 in the form of the focus error signal utilized in order that the position of the objective lens 122 corresponds to a focal distance where the laser beam is focused on the track (not shown) previously formed on the recording surface of the optical disk D or the pit string (not shown) which is of the recording information through the objective lens 122.

An adder 224 generates (A+C), and an adder 225 generates (B+D). The outputs (A+C) and (B+D) of the adders 224 and 225 are input to a phase-difference detector 232. The phase-difference detector 232 is useful for obtaining the accurate tracking error signal when the objective lens 122 is lens-shifted.

The sum of (A+B) and (C+D) is obtained by an adder 226 and supplied to a tracking control circuit 233 in the form of the tracking error signal.

(A+C) and (B+D) are further added by an adder 227, converted into an (A+B+C+D) signal, i.e. the reproducing signal, and input to a buffer memory 234.

The intensity of optical feedback of the laser beam emitted from the second laser element 131 is inputted to an APC circuit 239. This results in stabilization of the intensity of the recording laser beam emitted from the laser element 131 on the basis of the recording data stored in a recording data memory 236.

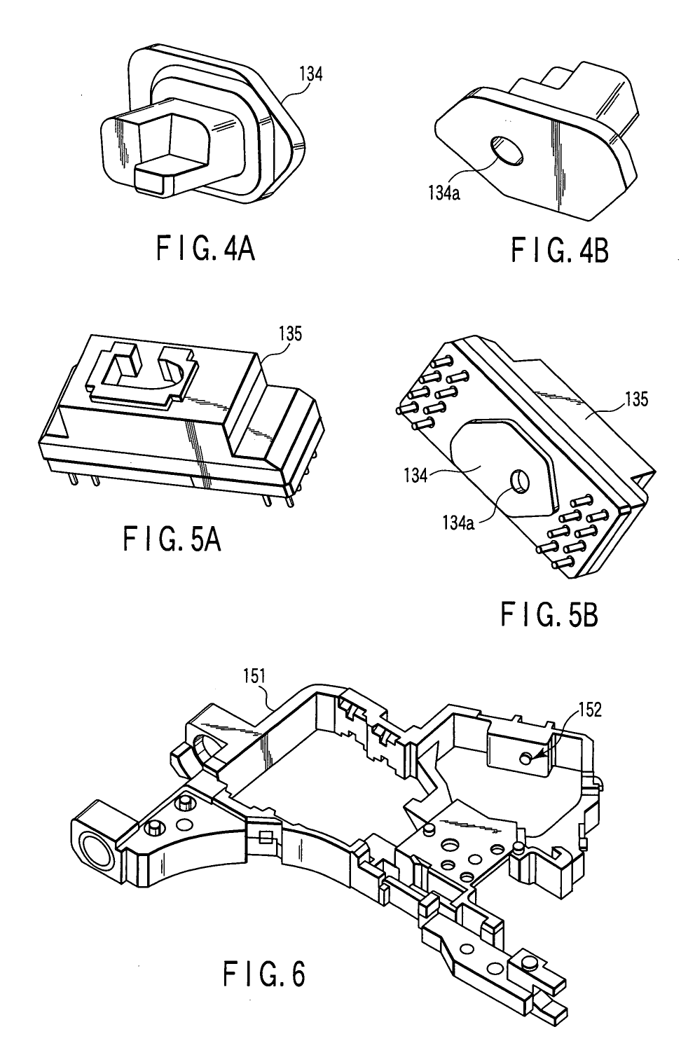

The second laser element 131 is integrated with a heat sink. 134, for example, as shown FIGS. 4A and 4B. As shown in FIGS. 5A and 5B, the second laser element is fixed to the predetermined position of a optical base 151 by positioning the unitized light-emitting/receiving unit 135 at a boss 152 of the optical base 151 described later by FIG. 6 and a positioning hole 134a in the heat sink 134.

However, it is known that the accuracy of position of the positioning hole 134a in the heat sink 134, positioning accuracy between the light-emitting/receiving unit 135 and the heat sink 134, accuracy in shape of each element, or the like might cause the unstable light-emitting position of the second laser element 131 located in the index hole 134a and light-emitting/receiving unit 135 or the unstable central position of the laser beam Lb emitted from the laser element 131. Further, in the laser beam emitted from the second laser element 131, it is well known that a spread angle of the laser element in the direction horizontal to the junction surface of the laser element chip is different from the spread angle in the direction vertical to the junction surface.

Namely, the simple fixation of the light-emitting/receiving unit 135 to the optical base 151 does not allows the center of the beam spot of the laser beam Lb to correspond to the center of the objective lens 122.

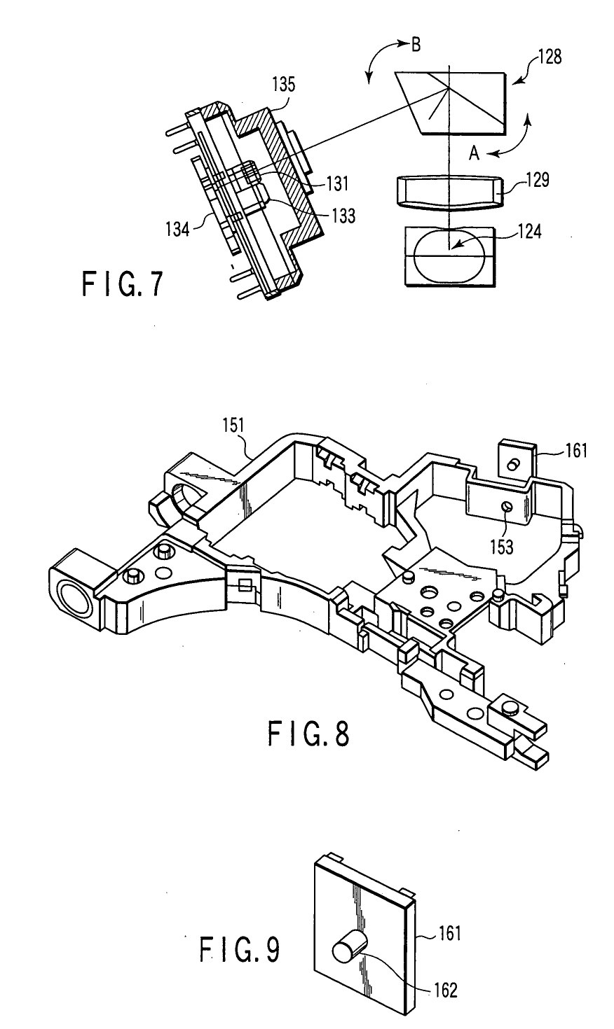

Therefore, in many cases, as shown in FIG. 7, the center of the beam spot of the laser beam Lb substantially corresponds to the center of the objective lens 122 by rotating the dichroic prism 128 in the direction of an arrow A or in the direction of an arrow B while the dichroic prism 128 is parallel to a plane including the optical axis between the prism mirror 124 and the dichroic prism 128 and the dichroic prism 128 and a reference axis of the light-emitting/receiving unit 135 when the optical pickup 121 is assembled.

However, as shown in FIG. 7, in the case where the direction of the main light beam of the laser beam emitted from the second laser element 131 is shifted from the center of the objective lens 122, even if the center of the beam spot of the laser beam Lb corresponds to the center of the objective lens 122, the accuracy of position on the side of the light-emitting/receiving unit 135 or fixing accuracy of the light-emitting/receiving unit 135 to the optical base 151 results in the large change in the intensity of the laser beam, i.e. an energy amount incident to the objective lens 122.

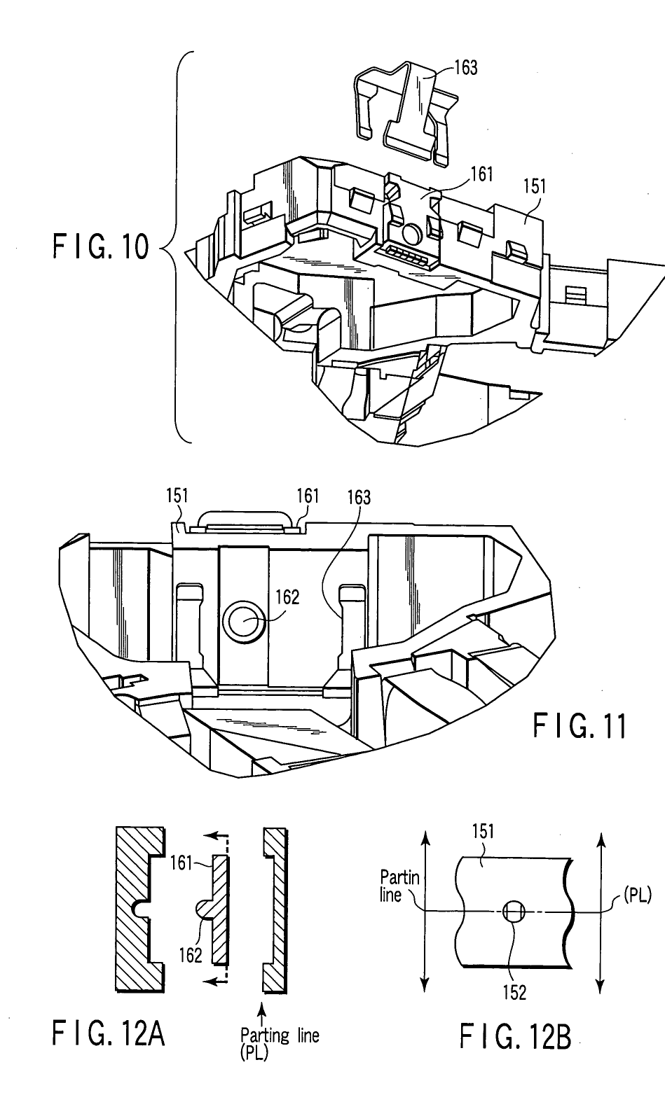

In order to solve the above problem, in the invention, a through hole 153 is provided in the optical base 151 as shown in FIG. 8, and a flat spring 163 presses a boss plate 161 shown in FIG. 9 in which a boss 162 is formed from the outside of the optical base 151 as shown in FIG. 10.

As shown in FIG. 11, the configuration shown in FIGS. 8 to 10 allows the boss (boss plate 161) to move (slide) to an arbitrary amount in the arbitrary direction orthogonal to the axial direction of the through hole 153 within the range of the through hole 153 in the optical base 151. Needless to say, the maximum value (alignment margin) in which the boss 162 in the boss plate 161 can be slid is arbitrarily set by properly setting the difference between diameters of the through hole 153 and the boss 162.

As shown in FIG. 12A, a parting line in die-cast molding exerts little influence on the boss plate 161 and the boss 162 by independently forming the boss plate 161 and the boss 162 from the optical base 151.

Accordingly, in the case where the boss plate 161 and the boss 162 are simultaneously formed with the optical base 151 as shown in FIG. 12B, it is not necessary to form a relief portion 152a which must be prepared in consideration of parting (a special shape of the boss which is not necessary for additional forming for removing a fin generated by metal mold parting).

Namely, the fixing accuracy of the boss plate 161 (boss 162) to the optical base 151 is also improved by independently preparing the boss 162 (boss plate 161) from the optical base 151 and fixing the boss 162 (boss plate 161) to the optical base 151 in the separated process as shown in FIGS. 8 to 10.

An example of the main process for assembling the optical pickup by using the boss, the boss plate, and the optical base shown in FIGS. 8 to 10 will be described below.

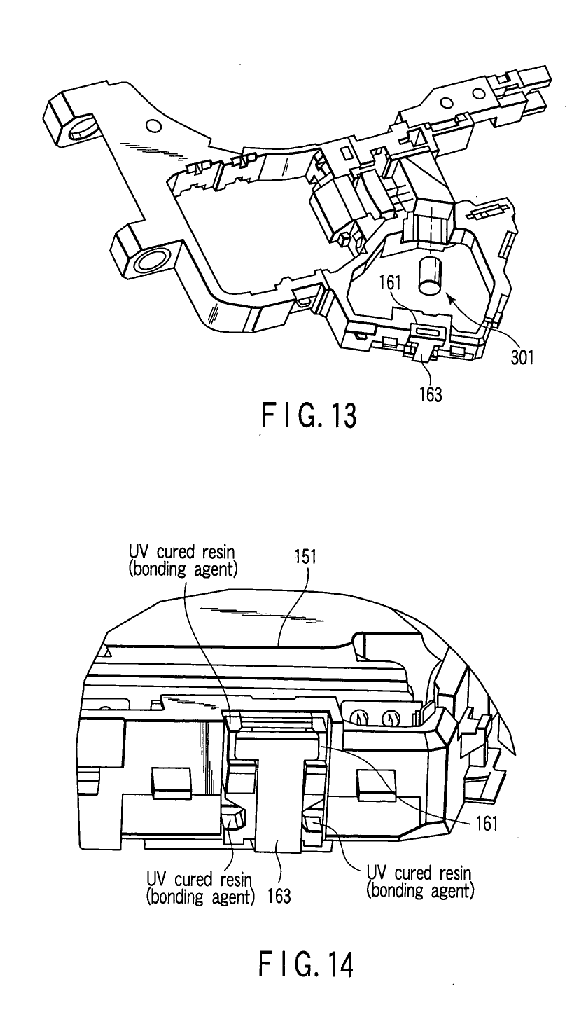

As shown in FIG. 13, the optical base 151 and the dichroic prism 128 are set to an assembly jig (not shown) in which a virtual (assembly) light source 301 is provided. The virtual light source 301 can provide a state in which the second laser element 131 is located at the design position.

By using an autocollimator (not shown), the dichroic prism 128 is located and fixed to the optical base 151 by bonding so that the light beam from the virtual light source 301 emitted from the dichroic prism 128 becomes the predetermined angle.

The boss plate 161, i.e. the boss 162 is set to the through hole 153 for the boss 162 in the optical base 151, and the boss plate 161 is pressed to the optical base 151 by using the flat spring 163.

Then, the light-emitting/receiving unit 135 is fixed to the boss 162 by the positioning hole 134a in the heat sink 134, and the second laser element 131 in the light-emitting/receiving unit 135 is emitted.

At this point, while the laser beam emitted from the dichroic prism 128 is monitored by the autocollimator, the boss plate 161 is moved in the arbitrary direction, an light-emitting point is moved onto the optical axis of the laser beam (axis line through which the laser beam should originally pass), and the boss plate 161 is stopped.

Since the flat spring 163 presses the boss plate 161 to the optical base 151, the position of the boss plate 161 is held even if slight vibration or external force is applied.

Then, as shown in FIG. 14, the boss plate 161 and the optical base 151 are bonded with UV cured adhesive which is cured by ultraviolet-ray irradiation (the UV cured resin is injected into a predetermined space between the boss plate 161 and the optical base 151, and irradiated with UV light having a predetermined wavelength).

More specifically, in the method of assembling the optical pickup shown in FIG. 13 and FIG. 14, a dual wavelength optical pickup device including the objective lens 122 which condenses the laser beam onto the optical disk D or captures the reflected light beam from the optical disk D, the prism mirror 124 which folds the optical path of the laser beam passing through the objective lens 122 at the predetermined angle, the first light source 125 which emits the light beam having the first wavelength, the second light source 131 (the light-emitting/receiving unit) which outputs the light beam having the second wavelength, the collimating lens 129 which collimates the light beam from the first light source, the dichroic prism 128 which transmits the light beam having the first wavelength collimated with the collimating lens 129 toward the prism mirror 124 and reflects the light beam from the second light source 131 toward the prism mirror 124, and the optical base 151 which holds each of elements, the optical pickup device is assembled by the steps of:

fixing the prism mirror 124 at a predetermined position in the optical base 151 directly or through a holding member;

fixing the collimating lens 129 at the predetermined position in the optical base 151 directly or through the holding member so that the light beam from the first light source 125 can be incident on the prism mirror 124 under a predetermined condition;

fixing the dichroic prism 128 at the predetermined position in the optical base 151 directly or through the holding member, while the virtual light source 301 for assembly is used instead of the second light source 131 and the light beam from the virtual light source 301 is monitored as the light beam reflected from the prism mirror 124;

positioning the second light source 131, which is fixed to the heat sink 134 on the basis of a monitor signal obtained by the alignment photodetector or a detector of autocollimator (not shown), at the predetermined position in the optical base 151; and

bonding a heat sink holding member 161 to the optical base 151, the heat sink holding member 161 holding the heat sink 134 so that a relative position between the heat sink 134 and the optical base 151 can be changed.

According to the method of the invention, the center of the laser beam emitted from the light source, i.e. the light-emitting/receiving unit can correspond to the substantial center of the objective lens, namely, the light-emitting point can be aligned on the optical axis of the laser beam (the axis line through which the laser beam should originally pass), and the energy of the laser beam condensed on the recording surface in the optical disk with the objective lens can be prevented from fluctuating undesirably. Further, an expensive measuring machine is not required, and manufacturing equipment which is currently utilized can be used as it is, so that the assembly cost is not affected.

Although the example of the light-emitting/receiving unit for writing the information in the DVD standard optical disk in the above-described embodiments, the invention can be also applied to the laser unit including the laser element for reproducing the information from the CD standard optical disk.

The invention is not limited to the above-described embodiments, and various changes and modifications can be made without departing from the spirit and scope of the invention in achievement of the invention. Further, each embodiment can be properly combined as much as possible, and an advantage generated by the combination can be obtained in that case.

As described above in detail, according to the invention, the center of the light beam from the light source can be incident on the objective lens, so that optical pickups having little variation can be obtained. Accordingly, the yield of the optical pickups is increased and the manufacturing cost is decreased.

In the optical disk device in which the optical pickup of the invention is incorporated, the recording state during recording the information in the optical disk is uniformed, so that possible generation of variation in the optical disk device is decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical pickup device comprising:
a light source which emits a light beam;
an optical base which holds the light source;
a dichroic prism which is fixed to the optical base, the dichroic prism reflecting the light beam emitted from the light source;
a mirror which is fixed to the optical base, the mirror receiving the light beam reflected from the dichroic prism;
a heat sink which is integrated with the light source, the heat sink releasing heat from the light source; and
a heat sink holding member which can position the heat sink at a predetermined position in the optical base.

2. An optical pickup device according to claim 1, wherein the heat sink holding member has a boss portion which is inserted into a through hole provided in the optical base and a plane portion in which the boss can be moved in the through hole in a direction orthogonal to an axis line of the boss.

3. An optical pickup device according to claim 2, wherein a holding member pressurizing mechanism and the heat sink holding member are located at the predetermined position in the optical base.

4. An optical pickup device according to claim 3, wherein the holding member pressurizing mechanism includes a spring member which presses the heat sink to the optical base so that the heat sink can be moved in a predetermined direction of the optical base.

5. An optical pickup device according to claim 2, wherein the heat sink holding member is fixed to the optical base by bonding.

6. An optical disk device comprising:
a light source which emits a light beam;
an optical base which holds the light source;
a dichroic prism which is fixed to the optical base, the dichroic prism reflecting the light beam emitted from the light source;
a mirror which is fixed to the optical base, the mirror receiving the light beam reflected from the dichroic prism;
a heat sink which is integrated with the light source, the heat sink releasing heat from the light source;
a heat sink holding member which can position the heat sink at a predetermined position in the optical base; and
a photodetector which detects the reflected light beam in which the light beam is reflected at a recording medium and outputs an electric signal having a magnitude corresponding to intensity of the reflected light beam.

7. An optical disk device according to claim 6, wherein the heat sink holding member is fixed to the optical base by bonding.

8. An optical disk device according to claim 6, wherein the heat sink holding member has a boss portion which is inserted into a through hole provided in the optical base and a plane portion in which the boss portion can be moved in the through hole in a direction orthogonal to an axis line of the boss portion.

9. A method of assembling a dual wavelength optical pickup device including an objective lens which condenses a light beam onto a recording medium or captures the light beam from a recording medium, a prism mirror which folds an optical path of the light beam passing through the objective lens at a predetermined angle, a first light source which emits a light beam having a first wavelength, a second light source which outputs a light beam having a second wavelength, a collimating lens which collimates the light beam from the first light source, a dichroic prism which transmits the light beam having the first wavelength collimated by the collimating lens toward the prism mirror and reflects the light beam from the second light source toward the prism mirror, and an optical base which holds each of elements, the method comprising the steps of:
fixing the prism mirror at a predetermined position in the optical base directly or through a holding member;
fixing the collimating lens at the predetermined position in the optical base directly or through the holding member so that the light beam from the first light source can be incident on the prism mirror under a predetermined condition;
fixing the dichroic prism at the predetermined position in the optical base directly or through the holding member, while a virtual light source for assembly is used instead of the second light source and the light beam from the virtual light source is monitored as the light beam reflected from the prism mirror;
positioning the second light source, which is fixed to a heat sink on the basis of a monitor signal obtained by an alignment photodetector or a detector of an autocollimator, at the predetermined position in the optical base; and
bonding a heat sink holding member to the optical base, the heat sink holding member holding the heat sink so that a relative position between the heat sink and the optical base can be changed.

10. A method of assembling an optical pickup device according to claim 9, wherein the heat sink holding member is fixed to the optical base by bonding.

11. A method of assembling an optical pickup device according to claim 10, wherein the heat sink holding member has a boss portion which is inserted into a through hole provided in the optical base and a plane portion in which the boss portion can be moved in the through hole in a direction orthogonal to an axis line of the boss portion, and a spring material presses the heat sink holding member to the optical base.

12. A method of assembling an optical pickup device according to claim 10, wherein the heat sink holding member is moved parallel to the plane portion and located at the predetermined position in the optical base so that the monitor signal obtained by the alignment photodetector or the detector of the autocollimator is maximized.
